(19) United States
(12) Patent Application Publication
(10) Pub. No.: US 2007/0171202 A1
(43) Pub. Date: Jul. 26, 2007

(54) Trajectory estimation apparatus, method, and medium for estimating two-dimensional trajectory of gesture

(75) Inventors: Jing Yang, Yongin-si (KR); Dong-yoon Kim, Seoul (KR); Won-chul Bang, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/651,531

(22) Filed: Jan. 10, 2007

(30) Foreign Application Priority Data
Jan. 24, 2006 (KR) 10-2006-0007239

(51) Int. Cl. G09G 5/08

(52) U.S. Cl. 345/158

(57) ABSTRACT

A trajectory estimation apparatus, method, and medium using a triaxial accelerometer are provided. The trajectory estimation apparatus includes a motion sensing module which measures an acceleration component for each of three axes from the input 3D gesture using a triaxial accelerometer, a gravitational component removal module which calculates a gravitational acceleration component and removes the gravitational acceleration component from the acceleration component, a gesture determination module which identifies gesture type represented by an acceleration component obtained as the result of the removal performed by the gravitational component removal module, and a compensation module which compensates for the acceleration component obtained as the result of the removal performed by the gravitational component removal module by using different compensation methods for different gesture types.

### CROSS-REFERENCE TO RELATED APPLICATIONS

This application claims priority from Korean Patent Application No. 10-2006-0007239 filed on Jan. 24, 2006 in the Korean Intellectual Property Office, the disclosure of which is incorporated herein by reference in its entirety.

### BACKGROUND OF THE INVENTION

1. Field of the Invention

The present invention relates to an apparatus, method, and medium for estimating the trajectory of a gesture using a triaxial accelerometer.

2. Description of the Related Art

Since the commencement of the digital era, the demand for accessing and generating digital data not only in places where computers are equipped but also everywhere else has steadily grown. The development and spread of personal portable devices have met this demand, but there is a long way to go to develop appropriate input devices for such personal portable devices. Input devices for personal portable devices are generally required to be portable and to facilitate user input, and thus, there is the need to develop input devices that are smaller than personal portable devices and are easy to carry. In order for users to easily input data to personal portable devices wherever they go, input devices which can allow the users to input data as naturally as they write things down on a notepad are needed. If input devices are capable of successfully restoring natural pen strokes made on an ordinary plane, in a free space, or on paper and thus allowing users to input various characters, figures, or gestures, they will be able to be used for various purposes and may not need special learning processes.

Therefore, in order to meet the aforementioned demands for input devices, input systems which can allow users to input data by gestures based on three-dimensional (3D) inertial navigation systems have been suggested.

Three-dimensional (3D) inertial navigation systems are systems which detect triaxial acceleration information and triaxial angular velocity information of an object that is currently moving in a 3D space and determine the position and attitude of the object using the detected information. 3D inertial navigation systems determine the posture of an object by integrating angular velocity information of the object, correct acceleration information of the object according to the results of the determination, obtains velocity information of the object by integrating the corrected acceleration information of the object, and obtains position information of the object by integrating the corrected acceleration information of the object twice.

FIG. 1 is a block diagram of an input system using a conventional inertial navigation system. Referring to FIG. 1, the input system includes a host device 20 and an input device 10.

The host device 20 displays an image corresponding to the motion of the input device 10 on the screen of the host device 20.

The input device 10 includes an acceleration sensor 11, an angular velocity sensor 12, a rotation angle information calculator 13, a conversion calculator 14, and a transmitter 15.

The acceleration sensor 11 generates acceleration information (A_{bx}, A_{by}, A_{bz}) according to the motion of the input device 10, wherein A_{bx}, A_{by}, and A_{bz} respectively represent x-axis acceleration information, y-axis acceleration information, and z-axis acceleration information of a body frame. Thereafter, the acceleration sensor 11 outputs the acceleration information to the conversion calculator 14.

A body frame is a frame from which acceleration information and angular velocity information can be detected in association with the motion of the input device 10. The body frame is differentiated from a navigation frame. A navigation frame is a reference frame for obtaining information, which can be applied to the host device 20, by applying a predetermined calculation matrix in consideration of information detected from a body frame.

The angular velocity sensor 12 generates angular velocity information (W_{bx}, W_{by}, W_{bz}) according to the motion of the input device 10, wherein W_{bx}, W_{by}, and W_{bz} respectively represent x-axis angular velocity information, y-axis angular velocity information, and z-axis angular velocity information of a body frame. Thereafter, the angular velocity sensor 12 outputs the angular velocity information to the rotation angle information calculator 13.

The rotation angle information calculator 13 receives the angular velocity information output by the angular velocity sensor 12. The rotation angle information calculator 13 converts the received angular velocity information into rotation angle information χ(φ, θ, ψ) by performing a predetermined computation process. The predetermined computation process is well known to one of ordinary skill in the art to which the present invention pertains, and thus, a detailed description of the predetermined computation process will not be presented in this disclosure.

The conversion calculator 14 receives the acceleration information output by the acceleration sensor 11 and the rotation angle information provided by the rotation angle information calculator 13. Then, the conversion calculator 14 determines the posture of the input device 10 with reference to the received rotation angle information, corrects the received acceleration information using the received rotation angle information, obtains velocity information by integrating the corrected acceleration information once, and obtains position information by integrating the corrected acceleration information twice.

However, input devices comprising both an acceleration sensor and an angular velocity sensor are relatively heavy and are thus deemed less portable. In general, angular velocity sensors are expensive, and thus, input devices using angular velocity sensors also become expensive.

In addition, input devices comprising both an acceleration sensor and an angular velocity sensor are likely to consume much power to drive the acceleration sensor and the angular velocity sensor. An initial correction operation is inevitable for input devices using angular velocity sensors, and this causes inconvenience.

### SUMMARY OF THE INVENTION

Additional aspects, features and/or advantages of the invention will be set forth in part in the description which follows and, in part, will be apparent from the description, or may be learned by practice of the invention.

The present invention provides an apparatus, method, and medium for reproducing a three-dimensional (3D) gesture trajectory as a two-dimensional signal by using a triaxial accelerometer.

According to an aspect of the present invention, there is provided a trajectory estimation apparatus for reproducing an input three-dimensional (3D) gesture into a two-dimensional (2D) signal. The trajectory estimation apparatus includes a motion sensing module which measures an acceleration component for each of three axes from the input 3D gesture using a triaxial accelerometer, a gravitational component removal module which calculates a gravitational acceleration component and removes the gravitational acceleration component from the acceleration component, a gesture determination module which identifies gesture type represented by an acceleration component obtained as the result of the removal performed by the gravitational component removal module, and a compensation module which compensates for the acceleration component obtained as the result of the removal performed by the gravitational component removal module by using different compensation methods for different gesture types.

According to another aspect of the present invention, there is provided a trajectory estimation method of reproducing an input three-dimensional (3D) gesture into a two-dimensional (2D) signal. The trajectory estimation method includes (a) measuring an acceleration component for each of three axes from the input 3D gesture using a triaxial accelerometer, (b) calculating a gravitational acceleration component and removing the gravitational acceleration component from the acceleration component, (c) identifying gesture type represented by an acceleration component obtained as the result of the removal performed in (b), and (d) compensating for the acceleration component obtained as the result of the removal performed in (b) using different compensation methods for different gesture types.

According to another aspect of the present invention, there is provided a trajectory estimation apparatus for reproducing an input three-dimensional (3D) gesture into a two-dimensional (2D) signal, the trajectory estimation apparatus including: a motion sensing module which measures an acceleration component from the input 3D gesture using a triaxial accelerometer; a gravitational component removal module which calculates a gravitational acceleration component and removes the gravitational acceleration component from the acceleration component; a gesture determination module which identifies gesture type represented by an acceleration component obtained as the result of the removal performed by the gravitational component removal module; and a compensation module which compensates for the acceleration component obtained as the result of the removal performed by the gravitational component removal module based on gesture types

According to another aspect of the present invention, there is provided a trajectory estimation method of reproducing an input three-dimensional (3D) gesture into a two-dimensional (2D) signal, the trajectory estimation method including: (a) measuring an acceleration component for each of three axes from the input 3D gesture using a triaxial accelerometer; (b) calculating a gravitational acceleration component and removing the gravitational acceleration component from the acceleration component; (c) identifying gesture type represented by an acceleration component obtained as the result of the removal performed in (b); and (d) compensating for the acceleration component obtained as the result of the removal performed in (b) based on gesture types.

According to another aspect of the present invention, at least one computer readable medium storing instructions that control at least one processor to perform a trajectory estimation method of reproducing an input three-dimensional (3D) gesture into a two-dimensional (2D) signal, the trajectory estimation method including: (a) measuring an acceleration component for each of three axes from the input 3D gesture using a triaxial accelerometer; (b) calculating a gravitational acceleration component and removing the gravitational acceleration component from the acceleration component; (c) identifying gesture type represented by an acceleration component obtained as the result of the removal performed in (b); and (d) compensating for the acceleration component obtained as the result of the removal performed in (b) based on gesture types.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram of an input device using a conventional inertial navigation system;

FIG. 2A is a diagram illustrating an example of a three-dimensional (3D) gesture trajectory;

FIG. 2B is a diagram illustrating three axial components of the 3D gesture trajectory illustrated in FIG. 2A;

FIG. 3A is a diagram for explaining a zero velocity compensation (ZVC) method;

FIG. 3B is a diagram for explaining a zero position compensation (ZPC) method;

FIG. 4 is a block diagram for a trajectory estimation apparatus according to an exemplary embodiment of the present invention;

FIG. 5A is a diagram illustrating three axial components of a measured acceleration;

FIG. 5B is a diagram illustrating three axial components of an estimated gravitational acceleration;

FIG. 6A is a diagram illustrating a gesture performed to draw the numeral ‘2’ on the x-y plane;

FIG. 6B is a diagram illustrating a gesture performed to draw the numeral ‘8’ on the x-y plane;

FIG. 6C is a diagram for explaining a rule for determining whether to apply estimated end position compensation (EPC) or ZPC;

FIG. 7 is a flowchart illustrating the operation of an estimated end position compensation EPC module; and

FIG. 8 is a diagram illustrating a gesture drawn on the x-y plane and explains max(Px)−min(Px) and dPx.

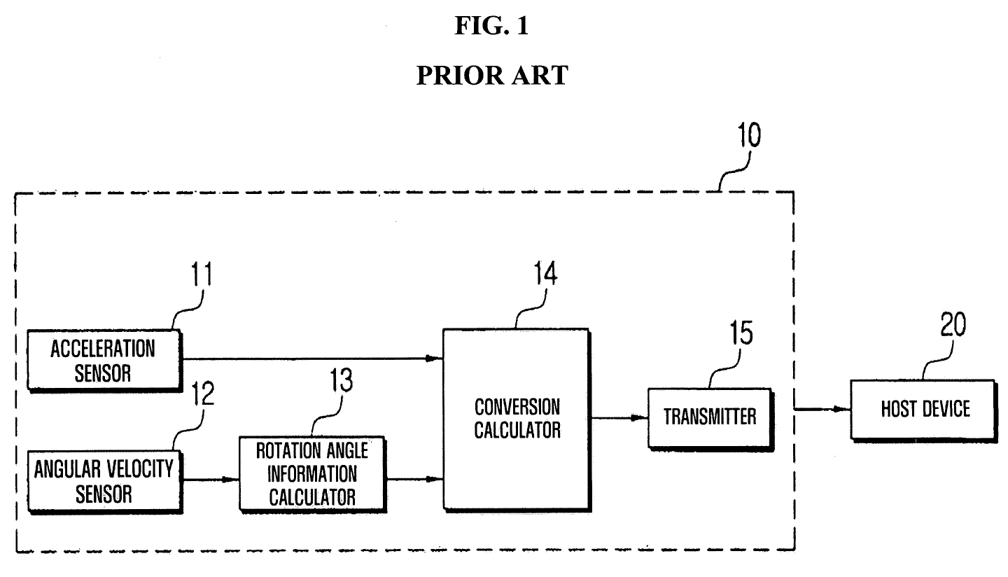

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The relationship between an acceleration component aₙ(t) output by a three-dimensional (3D) accelerometer, a gravitational component a_{gn}(t), a motion component aₘₙ(t) generated by a pure motion, and an error component eₙ(t) of a sensor may be defined by Equation (1):

aₙ(t)=a_{gn}(t)+aₘₙ(t)+eₙ(t) (1).

### Throughout this disclosure, subscript n indicates association with three axial directions, i.e., x-, y-, and z-axis directions, subscript g indicates association with gravity, and subscript m indicates association with motion.

As indicated by Equation (1), in order to precisely measure motion using an accelerometer, a gravitational component that varies over time must be removed, and the influence of a sensor error on the measurement of motion must be reduced.

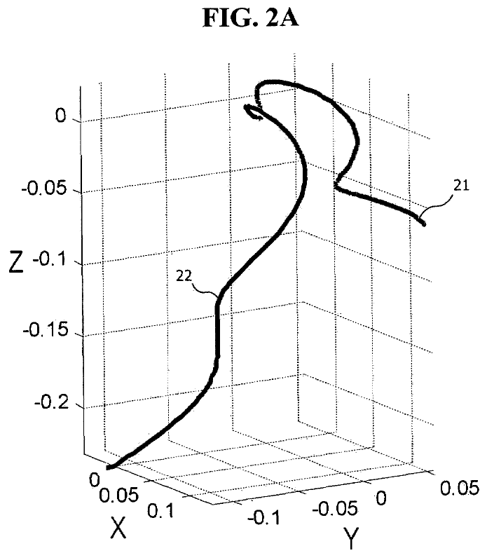

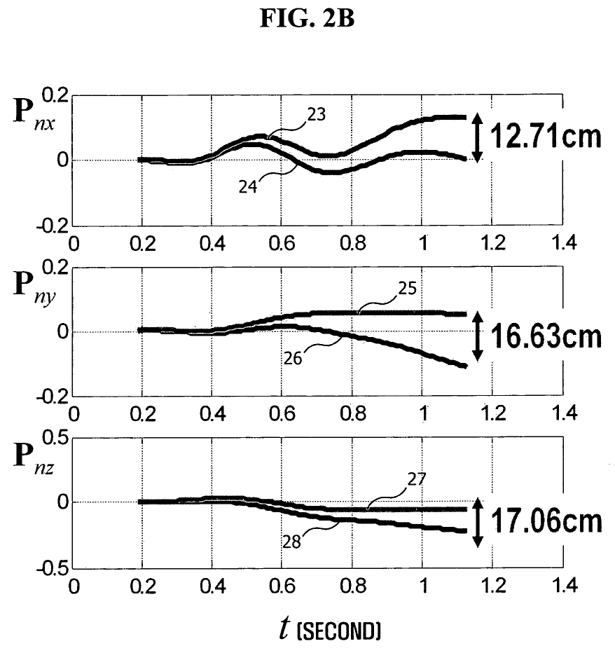

In general, a position cumulative error Pₙ, which occurs due to the existence of a constant acceleration error factor A_{b}, is proportional to the square of an elapsed time, and this will hereinafter be described in detail with reference to FIGS. 2A and 2B.

Referring to FIG. 2A, in a 3D space, an actual gesture trajectory 21 is slightly different from a measured trajectory 22 provided by an accelerometer. The difference between the actual gesture trajectory 21 and the measured trajectory 22 is projected onto each of the x-axis, the y-axis, and the z-axis, and the results of the projecting are illustrated in FIG. 2B. Referring to FIG. 2B, for some reason, a cumulative error increases over time proportionally to the square of an elapsed time. The reason the cumulative error increases over time differs from the one axis to another. A cumulative error (Pₙₓ) for the x-axis is 12.71 cm, a cumulative error (P_{ny}) for the y-axis is 16.63 cm, and a cumulative error (P_{nz}) for the z-axis is 17.06 cm.

Existing methods of compensating for a cumulative error when estimating a gesture trajectory on a plane by simply using a triaxial accelerometer without the aid of an angular velocity sensor include a zero velocity compensation (ZVC) method and a zero position compensation method (ZPC).

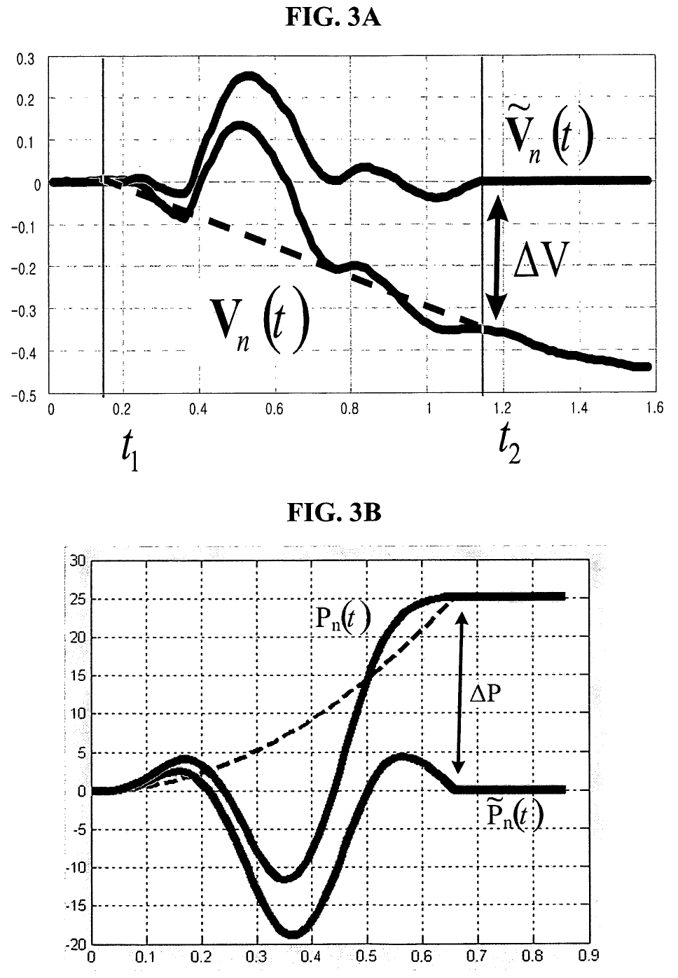

The ZVC method is based on the assumption that the velocity slightly before the performing of a gesture and the velocity slightly after the performing of the gesture are all zero. Accordingly, the ZVC method requires a pause period before and after the performing of a gesture. As described above, a position cumulative error increases proportionally to the square of an elapsed time, and thus, a velocity cumulative error increases proportionally to an elapsed time, as illustrated in FIG. 3A. Referring to FIG. 3A, assuming that an actual velocity is \tilde{V}ₙ(t), a velocity measured by an accelerometer is Vₙ(t), and a velocity cumulative error that has occurred between a time t1 and a time t2 is ΔV, the measured velocity Vₙ(t) can be properly compensated for using the velocity cumulative error ΔV and the actual time taken to perform a gesture.

The ZVC method provides excellent experimental results for most gestures. However, if a start point of a gesture is too much close to an end point of the gesture, i.e., if the gesture is a closed gesture, the ZVC method may not be able to provide excellent performance.

On the other hand, the ZPC method is based on the assumption that the position where a gesture begins and the position where the gesture ends are all zero. Referring to FIG. 3B, a position cumulative error increases proportionally to the square of an elapsed time. Assuming that an actual position is Pₙ(t), a position measured by an accelerometer is \tilde{P}ₙ(t), and a cumulative error that has occurred between a time t1 and a time t2 is ΔP, the measured position \tilde{P}ₙ(t) can be properly compensated for by using the position cumulative error ΔP and the actual time taken to perform a gesture.

In the ZPC method, a start point and an end point of a gesture are deemed to coincide with each other. Thus, the ZPC method may be able to guaranty excellent performance for closed gestures. However, the ZPC method may not be able to provide excellent performance for open gestures.

In order to address the problems of the ZVC method and the ZPC method, the present invention provides an estimated end position compensation (EPC) method. The EPC method is characterized in that:
(1) the type of an input gesture is identified, i.e., it is determined whether the input gesture is a closed gesture or an open gesture, given that the human arm rotates about a certain axis;
(2) different compensation techniques are applied to different types of gestures; and
(3) an end point of the input gesture is estimated in consideration of the properties of human body movement, and the result of the estimation is used to compensate for an entire trajectory of the input gesture.

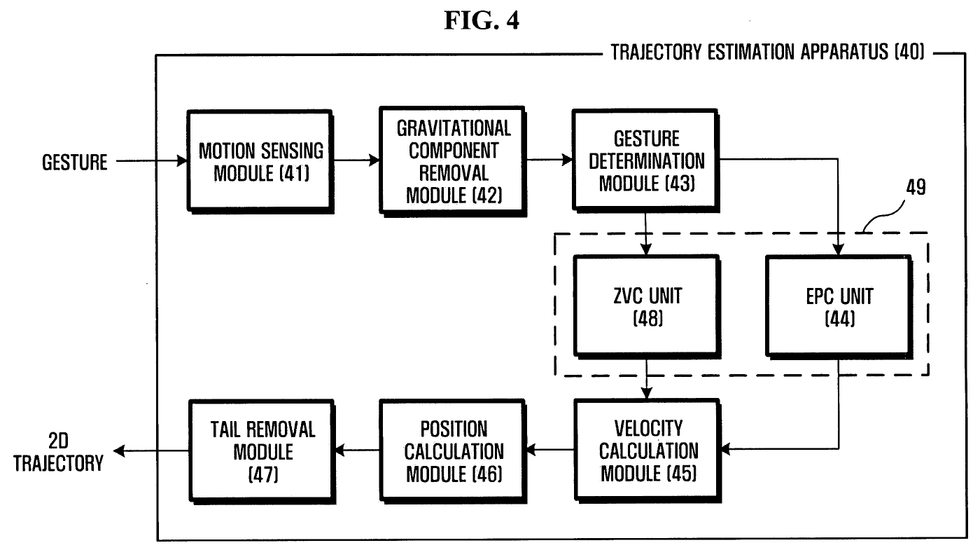

FIG. 4 is a block diagram of a trajectory estimation apparatus 40 according to an exemplary embodiment of the present invention. Referring to FIG. 4, the trajectory estimation apparatus 40 includes a motion sensing module 41, a gravitational component removal module 42, a gesture determination module 43, an EPC module (end position compensator) 44, a velocity calculation module 45, a position calculation module 46, a tail removal module 47, and a ZVC module (zero velocity compensator) 48. The EPC module 44 and the ZVC module 48 are included in a compensation module 49.

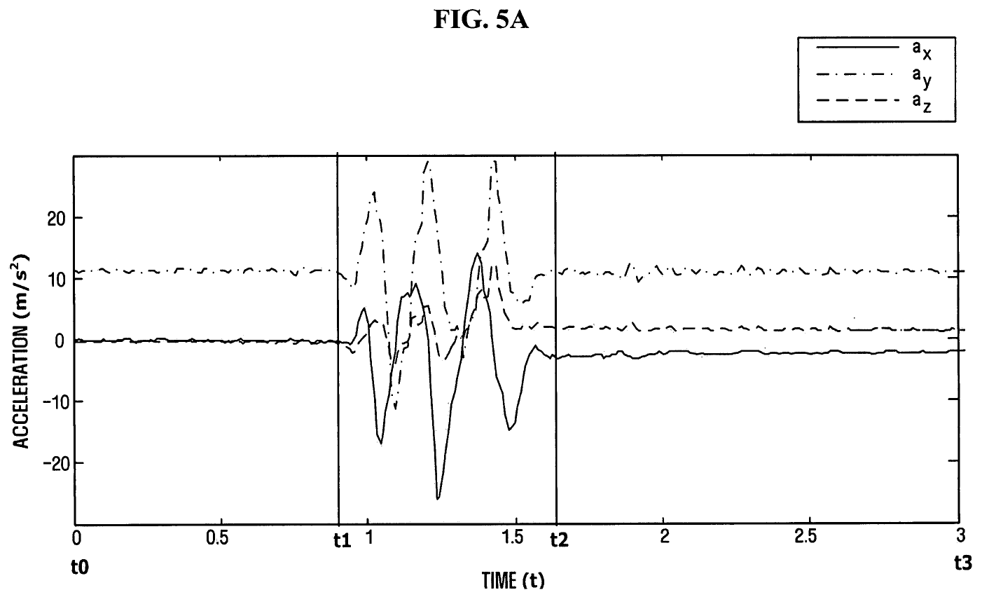

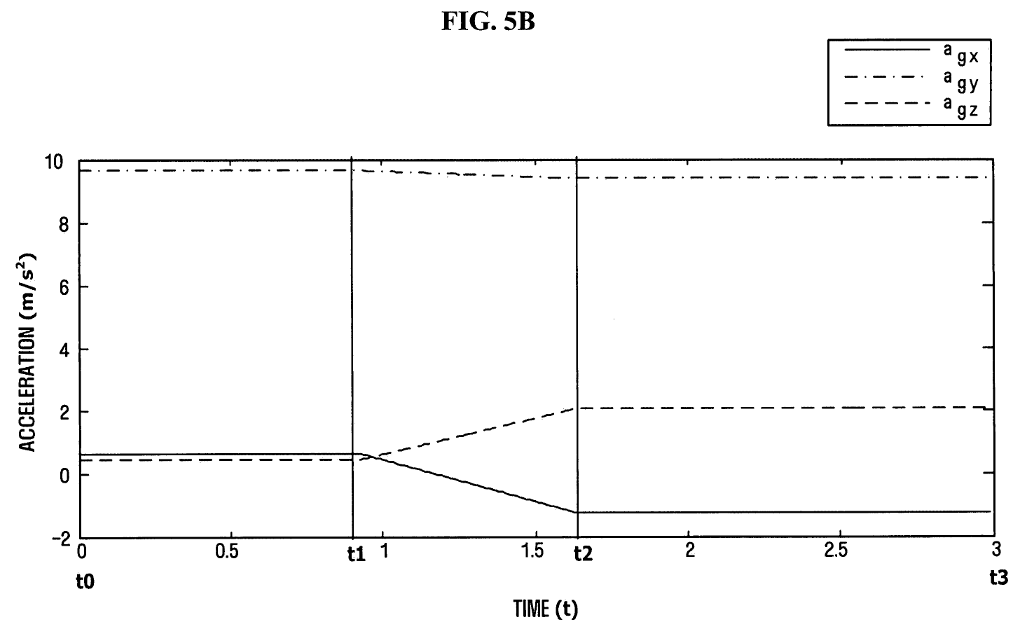

The motion sensing module 41 senses the acceleration of an object according to a user's gesture. The motion sensing module 41 may be comprised of a triaxial accelerometer. The output of the motion sensing module 41 is an acceleration component aₙ(t) for each of the three axial directions. An example of the acceleration component aₙ(t) is illustrated in FIG. 5A. Assume that, of the x-, y-, and z-axes, the y-axis is opposite to a gravity direction.

For motion that begins at a time t1 and ends at a time t2, acceleration must be constant before the initiation of the motion, but slightly fluctuates during a time period between t0 and t1 due to noise. Likewise, the acceleration slightly fluctuates even after the motion ends, particularly, during a time period between t2 and t3.

The gravitational component removal module 42 removes a gravitational component from the acceleration component for each of the three axial directions. A gravitational component for a pause period is equal to a gravitational component at the beginning and ending of the pause period.

In other words, a gravitational acceleration â_{gn}(t) during the time period between to and t1 is equal to a gravitational acceleration â_{gn}(t1) at t1, and a gravitational acceleration â_{gn}(t) during the time period between t2 and t3 is equal to a gravitational acceleration â_{gn}(t2) at t2. In this disclosure, reference characters to which hat (̂) is attached represent estimated values.

Assuming that human body parts rotate about a certain axis, gravitational acceleration is likely to linearly change during a motion period, i.e., during the time period between t1 and t2. Three gravitational components measured for the respective three acceleration components measured as indicated by FIG. 5A are illustrated in FIG. 5B. Referring to FIG. 5B, each of the acceleration components linearly increases or decreases between a pair of estimated values for either end of the time period between t1 and t2, i.e., between â_{gn}(t1) and â_{gn}(t2).

As described above, the gravitational acceleration â_{gn}(t) during the time period between t1 and t2 may be indicated by Equation (2):

â_{gn}(t)=k(t−t1)+â_{gn}(t1)

k=[â_{gn}(t)−â_{gn}(t1)]/(t2−t1) (2).

The gravitational component removal module 42 removes the gravitational acceleration â_{gn}(t), which is determined as indicated by Equation (2), from the acceleration aₙ(t), which is measured by the motion sensing module 41.

The gesture determination module 43 determines whether an input gesture is an open gesture or a closed gesture, i.e., determines the type of the input gesture, using an acceleration component aₘₙ′(t) obtained as the result of the removal performed by the gravitation component removal module 42.

For this, the gesture determination module 43 measures a pitch θ1 at the time (t1) when the motion begins and a pitch at the time (t2) when the motion ends, and calculates a difference dθ (=θ2−θ1) between the pitch θ1 and the pitch θ2. If the difference dθ is within the range of a first threshold and a second threshold, the gesture determination module 43 determines that the input gesture is a closed gesture. On the other hand, if the difference dθ is outside the range of the first threshold and the second threshold, the gesture determination module 43 determines that the input gesture is an open gesture.

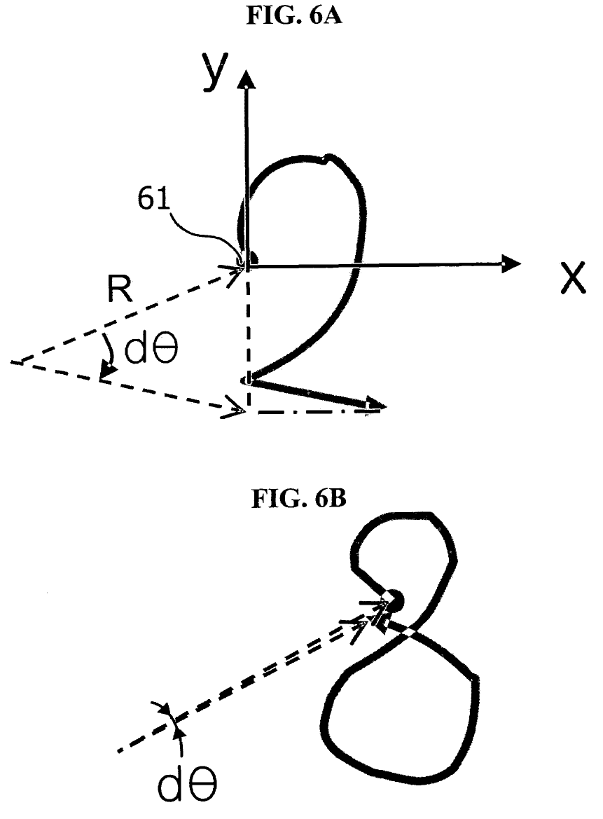

FIG. 6A illustrates a gesture performed to draw the numeral “2”, and FIG. 6B illustrates a gesture performed to draw the numeral “8”. The gesture illustrated in FIG. 6A is determined to be an open gesture because a difference dθ between a start pitch θ1 and an end pitch θ2 of the gesture illustrated in FIG. 6A is outside the range of a first threshold Th1 and a second threshold Th2. On the other hand, the gesture illustrated in FIG. 6B is determined to be a closed gesture because a difference dθ between a start pitch θ1 and an end pitch θ2 of the gesture illustrated in FIG. 6B is within the range of the first threshold Th1 and the second threshold Th2.

In short, referring to FIG. 6C, it is determined whether to use a typical ZVC algorithm or an EPC algorithm according to the present invention by determining whether the difference dθ between the pitch θ1 and the pitch θ2 of the input gesture is within the range of the first threshold Th1 and the second threshold Th2. If the difference dθ between the pitch θ1 and the pitch θ2 of the input gesture is within the range of the first threshold Th1 and the second threshold Th2, the EPC algorithm may be used. In this case, the EPC module 44 is driven.

The ZVC module 48 compensates for error using a ZVC algorithm described above with reference to FIG. 3A if an acceleration component output by the gravitational component removal module 42 corresponds to an open gesture.

The EPC module 44 compensates for error using the EPC algorithm according to the present invention if the acceleration component output by the gravitational component removal module 42 corresponds to a closed gesture. The acceleration component output by the gravitational component removal module 42 is (âₘₓ(t),â_{my}(t)) where x and y represents a virtual plane on which a gesture is drawn.

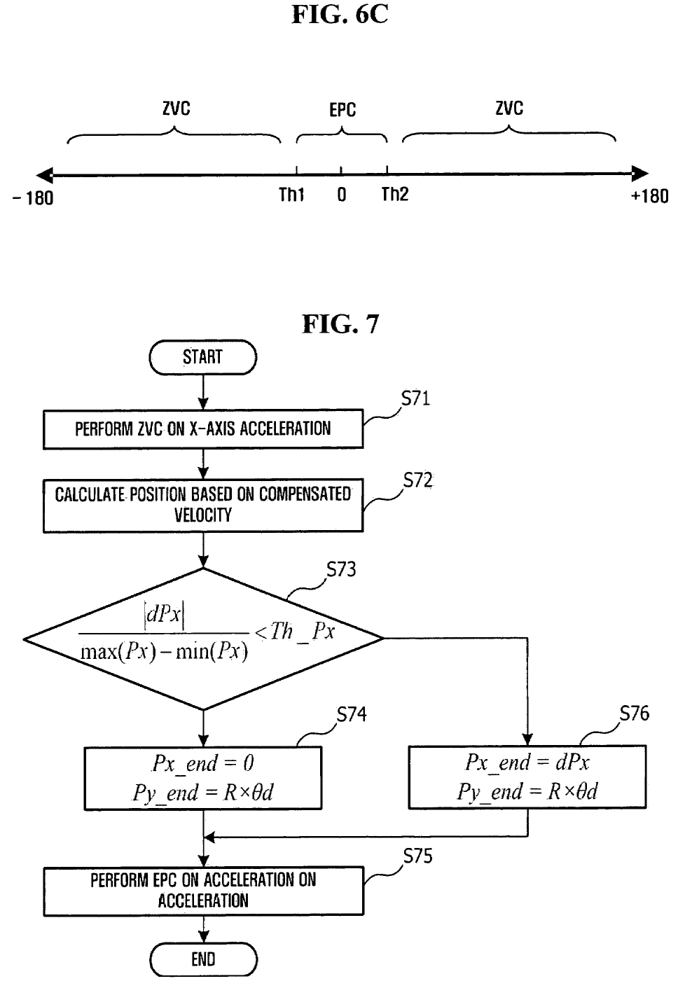

FIG. 7 is a flowchart illustrating the operation of the EPC module 44. Referring to FIG. 7, in operation S71, the EPC module 44 performs ZVC, which is described above with reference to FIG. 3A, on the x-axis acceleration component âₘₓ(t). In operation S72, the EPC module 44 calculates a position Pₓ(t) by integrating the result of the ZVC performed in operation S71.

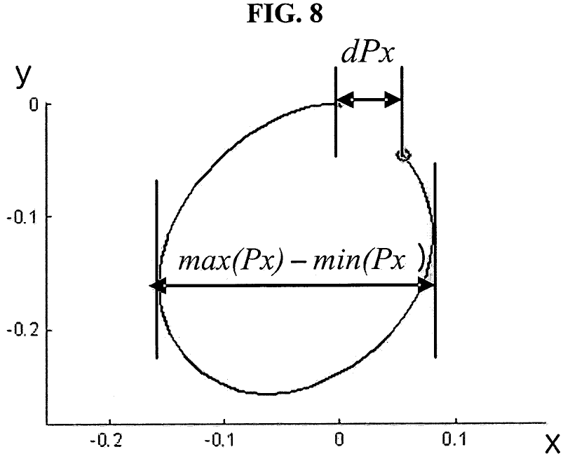

In operation S73, the EPC module 44 determines whether a difference dPx between an x component of one end of a gesture trajectory and an x component of the other end of the gesture trajectory divided by a difference (max(Pₓ)−min(Pₓ)) between a maximum x value max(Pₓ) and a minimum x value min(Pₓ) of the gesture trajectory is smaller than a predefined threshold Th_Pₓ in order to determine in consideration of a gesture whether an x coordinate of a start point of the gesture is close to an x coordinate of an end point of the gesture. The difference max(Pₓ)−min(Pₓ) and the difference dPₓ will become more apparent by reference to FIG. 8, which illustrates a gesture drawn on the x-y plane.

In operation S74, if the difference dPₓ is determined in operation S73 to be smaller than the predefined threshold Th_Pₓ, the start point and the end point of the gesture are deemed to coincide with each other, and thus, an x coordinate Pₓ_{_{—}}end of an estimated end position is set to 0. In operation S76, if the difference dPₓ is determined in operation S73 not to be smaller than the predefined threshold Th_Pₓ, the start point and the end point of the gesture are deemed not to coincide with each other, and thus, the x coordinate Pₓ_{_{—}}end of the estimated end position is set to be equal to the difference dPₓ.

In operations S74 and S76, a y coordinate P_{y}_{_{—}}end of the estimated end position is determined as the square of the difference between a rotation radius R and the difference dθ, as illustrated in FIG. 6A, because the gesture determination module 43 determines the difference dθ to be inconsiderable.

In operation S75, the EPC module 44 performs EPC on the acceleration component (âₘₓ(t),â_{my}(t)) by using the estimated end position Pₙ_{_{—}}end (where n=x or y).

In detail, the EPC module 44 does not perform any compensation on but integrates the acceleration component (âₘₓ(t),â_{my}(t)), thereby obtaining an end position Pₙ(t2) (where where n=x or y).

Thereafter, an acceleration difference Δâₘₙ(t) is modeled as a constant, linear, or another relationship.

For example, the acceleration difference Δâₘₙ(t) may be modeled as a constant relationship according to boundary conditions, as indicated by Equation (3):

Δâₘₙ(t) [Pₙ(t2)−Pₙ_{_{—}}end]/0.5(t2−t1)² (3)

where n=x or y.

Finally, an estimated-end-position-compensated acceleration âₘₙ′(t) for the time period between t1 and t2 can be determined, as indicated by Equation (4):

âₘₙ′(t)=âₘₙ(t)−Δâₘₙ(t) (4).

The velocity calculation module 45 calculates velocity by integrating the estimated-end-position-compensated acceleration âₘₙ′(t), and the position calculation module 46 calculates position by integrating the velocity calculated by the velocity calculation module 45, thereby obtaining a 2D trajectory of the input gesture.

The tail removal module 47 removes an unnecessary tail portion of a figure or character represented by the input gesture. Given that the tail of the figure or character represented by the input gesture is likely to correspond to the end position of the input gesture, the tail removal module 47 cuts off a portion of a final stroke that extends in the same direction.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions are stored/transferred and executed in a distributed fashion. The medium/media may also be the Internet. The computer readable code/instructions may be executed by one or more processors. The computer readable code/instructions may also be executed and/or embodied in at least one application specific integrated circuit (ASIC) or Field Programmable Gate Array (FPGA).

In addition, one or more software modules or one or more hardware modules may be configured in order to perform the operations of the above-described exemplary embodiments.

The term “module”, as used herein, denotes, but is not limited to, a software component, a hardware component, or a combination of a software component and hardware component, which performs certain tasks. A module may advantageously be configured to reside on the addressable storage medium/media and configured to execute on one or more processors. Thus, a module may include, by way of example, components, such as software components, application specific software components, object-oriented software components, class components and task components, processes, functions, operations, execution threads, attributes, procedures, subroutines, segments of program code, drivers, firmware, microcode, circuitry, data, databases, data structures, tables, arrays, and variables. The functionality provided for in the components or modules may be combined into fewer components or modules or may be further separated into additional components or modules. Further, the components or modules can operate at least one processor (e.g. central processing unit (CPU)) provided in a device. In addition, examples of a hardware component include an application specific integrated circuit (ASIC) and Field Programmable Gate Array (FPGA). As indicated above, a module can also denote a combination of a software component(s) and a hardware component(s).

The computer readable code/instructions and computer readable medium/media may be those specially designed and constructed for the purposes of the present invention, or they may be of the kind well-known and available to those skilled in the art of computer hardware and/or computer software.

As described above, the trajectory estimation apparatus, method, and medium according to the present invention can reproduce a 3D gesture trajectory as a 2D plane signal using a triaxial accelerometer.

Therefore, according to the present invention, it is possible to precisely input characters or figures to small devices such as mobile phones or personal digital assistants (PDAs) by using gestures.

Although a few exemplary embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A trajectory estimation apparatus for reproducing an input three-dimensional (3D) gesture into a two-dimensional (2D) signal, the trajectory estimation apparatus comprising:
a motion sensing module which measures an acceleration component from the input 3D gesture using a triaxial accelerometer;
a gravitational component removal module which calculates a gravitational acceleration component and removes the gravitational acceleration component from the acceleration component;
a gesture determination module which identifies gesture type represented by an acceleration component obtained as the result of the removal performed by the gravitational component removal module; and
a compensation module which compensates for the acceleration component obtained as the result of the removal performed by the gravitational component removal module based on gesture types.

2. The trajectory estimation apparatus of claim 1, wherein the gesture types comprise a closed gesture type and an open gesture type.

3. The trajectory estimation apparatus of claim 2, wherein the gesture determination module determines whether a difference between a gravity directional component of a start point of the input 3D gesture and a gravity directional component of an end point of the input 3D gesture is within a predetermined threshold range.

4. The trajectory estimation apparatus of claim 3, wherein the gesture determination module measures a first pitch at the start point of the input 3D gesture and a second pitch at the end point of the input 3D gesture, calculates a difference between the first pitch and the second pitch, determines the input 3D gesture to be a closed gesture if the difference between the first pitch and the second pitch is within the predetermined threshold range, and determines the input 3D gesture to be an open gesture if the difference between the first pitch and the second pitch is outside the predetermined threshold range.

5. The trajectory estimation apparatus of claim 1, wherein the gravitational component removal module calculates the gravitational acceleration component based on gravitational acceleration linearly changing between an acceleration level slightly before the performing of a gesture and an acceleration level slightly after the performing of the gesture.

6. The trajectory estimation apparatus of claim 1, wherein the compensation module comprises:
a zero velocity compensator which performs zero velocity compensation (ZVC) on the acceleration component obtained as the result of the removal performed by the gravitational component removal module if the input gesture is a closed gesture; and
an estimated end position compensator which performs end position compensation (EPC) on the acceleration component obtained as the result of the removal performed by the gravitational component removal module if the input gesture is an open gesture.

7. The trajectory estimation apparatus of claim 6, wherein the end position compensator performs ZVC on an x component of the acceleration component obtained as the result of the removal performed by the gravitational component removal module, calculates a 2D trajectory by integrating the result of the ZVC, and determines whether a difference between an x component of one end point of the 2D trajectory and an x component of the other end point of the 2D trajectory divided by a difference between a maximum x value and a minimum x value of the 2D trajectory is smaller than a predetermined threshold.

8. The trajectory estimation apparatus of claim 7, wherein, if the difference between the x component of one end point of the 2D trajectory and the x component of the other end point of the 2D trajectory divided by the difference between the maximum x value and the minimum x value of the 2D trajectory is determined to be smaller than the predetermined threshold, the end position compensator sets an x coordinate of an estimated end position to 0, and if the difference between the x component of one end point of the 2D trajectory and the x component of the other end point of the 2D trajectory divided by the difference between the maximum x value and the minimum x value of the 2D trajectory is determined not to be smaller than the predetermined threshold, the end position compensator sets the x coordinate of the estimated end position to be the same as that of an actual end point of the input 3D gesture.

9. The trajectory estimation apparatus of claim 8, wherein the end position compensator performs EPC on the acceleration component obtained as the result of the removal performed by the gravitational component removal module using the x coordinate of the estimated end position and a y coordinate of the estimated end position, wherein the y coordinate of the estimated end position is determined as the square of a difference between a rotation radius and the difference between the first pitch and the second pitch.

10. The trajectory estimation apparatus of claim 9, wherein the end position compensator calculates an x coordinate of an uncompensated end position by integrating the acceleration component obtained as the result of the removal performed by the gravitational component removal module, models an acceleration difference component using the x coordinate of the uncompensated end position and the x coordinate of the estimated end position, and divides the acceleration difference component by the acceleration component obtained as the result of the removal performed by the gravitational component removal module.

11. The trajectory estimation apparatus of claim 10, wherein the end position compensator calculates a y coordinate of an uncompensated end position by integrating the acceleration component obtained as the result of the removal performed by the gravitational component removal module, models an acceleration difference component using the y coordinate of the uncompensated end position and the y coordinate of the estimated end position, and divides the acceleration difference component by the acceleration component obtained as the result of the removal performed by the gravitational component removal module.

12. The trajectory estimation apparatus of claim 10, wherein the acceleration difference component is modeled as a constant or is linearly modeled.

13. The trajectory estimation apparatus of claim 1 further comprising a velocity and position calculation module which calculates a 2D trajectory by integrating the compensated acceleration component.

14. The trajectory estimation apparatus of claim 13 further comprising a tail removal module, which removes a tail of the 2D trajectory.

15. A trajectory estimation method of reproducing an input three-dimensional (3D) gesture into a two-dimensional (2D) signal, the trajectory estimation method comprising:
(a) measuring an acceleration component for each of three axes from the input 3D gesture using a triaxial accelerometer;
(b) calculating a gravitational acceleration component and removing the gravitational acceleration component from the acceleration component;
(c) identifying gesture type represented by an acceleration component obtained as the result of the removal performed in (b); and
(d) compensating for the acceleration component obtained as the result of the removal performed in (b) based on gesture types.

16. The trajectory estimation method of claim 15, wherein the gesture types comprise a closed gesture type and an open gesture type.

17. The trajectory estimation method of claim 16, wherein (c) comprises determining whether a difference between a gravity directional component of a start point of the input 3D gesture and a gravity directional component of an end point of the input 3D gesture is within a predetermined threshold range.

18. The trajectory estimation method of claim 17, wherein (c) comprises:
measuring a first pitch at the start point of the input 3D gesture and a second pitch at the end point of the input 3D gesture; and
calculating a difference between the first pitch and the second pitch, determining the input 3D gesture to be a closed gesture if the difference between the first pitch and the second pitch is within the predetermined threshold range, and determining the input 3D gesture to be an open gesture if the difference between the first pitch and the second pitch is outside the predetermined threshold range.

19. The trajectory estimation method of claim 15, wherein (b) comprises calculating the gravitational acceleration component based on gravitational acceleration linearly changing between an acceleration level slightly before the performing of a gesture and an acceleration level slightly after the performing of the gesture.

20. The trajectory estimation method of claim 15, wherein (d) comprises:
(d1) performing zero velocity compensation (ZVC) on the acceleration component obtained as the result of the removal performed in (b); and
(d2) performing end position compensation (EPC) on the acceleration component obtained as the result of the removal performed in (b) if the input gesture is an open gesture.

21. The trajectory estimation method of claim 20, wherein (d2) comprises:
performing ZVC on an x component of the acceleration component obtained as the result of the removal performed in (b);
calculating 2D trajectory by integrating the result of the ZVC; and
determining whether a difference between an x component of one end point of the 2D trajectory and an x component of the other end point of the 2D trajectory divided by a difference between a maximum x value and a minimum x value of the 2D trajectory is smaller than a predetermined threshold.

22. The trajectory estimation method of claim 21, wherein, if the difference between the x component of one end point of the 2D trajectory and the x component of the other end point of the 2D trajectory divided by the difference between the maximum x value and the minimum x value of the 2D trajectory is determined to be smaller than the predetermined threshold, (d2) comprises setting an x coordinate of an estimated end position to zero, and if the difference between the x component of one end point of the 2D trajectory and the x component of the other end point of the 2D trajectory divided by the difference between the maximum x value and the minimum x value of the 2D trajectory is determined not to be smaller than the predetermined threshold, (d2) comprises setting the x coordinate of the estimated end position to be the same as that of an actual end point of the input 3D gesture.

23. The trajectory estimation method of claim 22, wherein (d2) comprises performing EPC on the acceleration component obtained as the result of the removal performed in (b) using the x coordinate of the estimated end position and a y coordinate of the estimated end position, wherein the y coordinate of the estimated end position is determined as the square of a difference between a rotation radius and the difference between the first pitch and the second pitch.

24. The trajectory estimation method of claim 23, wherein (d2) comprises:
calculating an x coordinate of an uncompensated end position by integrating the acceleration component obtained as the result of the removal performed in (b);
modeling an acceleration difference component using the x coordinate of the uncompensated end position and the x coordinate of the estimated end position; and
dividing the acceleration difference component by the acceleration component obtained as the result of the removal performed in (b).

25. The trajectory estimation method of claim 23, wherein (d2) comprises:
calculating a y coordinate of an uncompensated end position by integrating the acceleration component obtained as the result of the removal performed in (b);
modeling an acceleration difference component using the y coordinate of the uncompensated end position and the y coordinate of the estimated end position; and
dividing the acceleration difference component by the acceleration component obtained as the result of the removal performed in (b)

26. The trajectory estimation method of claim 24, wherein the acceleration difference component is modeled as a constant or is linearly modeled.

27. The trajectory estimation method of claim 15 further comprising calculating a 2D trajectory by integrating the compensated acceleration component.

28. The trajectory estimation method of claim 27 further comprising removing a tail of the 2D trajectory.

29. At least one computer readable medium storing instructions that control at least one processor to perform a trajectory estimation method of reproducing an input three-dimensional (3D) gesture into a two-dimensional (2D) signal, the trajectory estimation method comprising:
(a) measuring an acceleration component for each of three axes from the input 3D gesture using a triaxial accelerometer;
(b) calculating a gravitational acceleration component and removing the gravitational acceleration component from the acceleration component;
(c) identifying gesture type represented by an acceleration component obtained as the result of the removal performed in (b); and
(d) compensating for the acceleration component obtained as the result of the removal performed in (b) based on gesture types.

30. At least one computer readable medium as recited in claim 29, wherein the gesture types comprise a closed gesture type and an open gesture type.

31. At least one computer readable medium as recited in claim 29, wherein (d) comprises:
(d1) performing zero velocity compensation (ZVC) on the acceleration component obtained as the result of the removal performed in (b); and
(d2) performing end position compensation (EPC) on the acceleration component obtained as the result of the removal performed in (b) if the input gesture is an open gesture.
